(19) United States
(12) Patent Application Publication
(10) Pub. No.: US 2024/0157611 A1
(43) Pub. Date: May 16, 2024

(54) MAKING SOFT GOODS FROM A SYSTEM OF MOLDING AND PRESSING USING A SLURRY CONTAINING FIBERS

(71) Applicant: Simplifyber, Inc., Raleigh, NC (US)

(72) Inventors: Maria Intscher-Owrang, Brooklyn, NY (US); Philip Cohen, Nashville, TN (US); Joseph Miller, Raleigh, NC (US); Juliana Marangon Jardim, Raleigh, NC (US); William Benjamin Montgomery Tew, Whitby (GB)

(21) Appl. No.: 18/511,469

(22) Filed: Nov. 16, 2023

Related U.S. Application Data
(60) Provisional application No. 63/425,763, filed on Nov. 16, 2022.

(51) Int. Cl. B29C 43/00; B29C 43/36

(52) U.S. Cl. CPC B29C 43/006; B29C 43/36

(57) ABSTRACT

The present invention discloses a method and apparatus for molding a fibrous molded article. An aqueous slurry that contains an amount of water and a plurality of fibers is added to the molding apparatus. First and second molding screens are positioned on a first pressing unit and a second pressing unit, respectively, and include a plurality of openings. The first and second molding screens can include secondary relief features. A pressing chamber sleeve slidably engages with the first pressing unit and the second pressing unit to ensure proper alignment during molding operation. The first and second molding screens at least partially form a void that is intended to receive an amount of the aqueous slurry. The apparatus includes a heat and pressure source that removes at least some of the water from the aqueous slurry and bonds the fibers to one another resulting in the fibrous molded article.

### PRIORITY CLAIM

This application claims the benefit of U.S. Provisional Patent Application Ser. No. 63/425,763 filed on Nov. 16, 2022, which is incorporated by reference herein in its entirety.

### FIELD OF THE INVENTION

The field of the invention is apparatus and method for molding a three-dimensional article and, more specifically, for molding a two- or three-dimensional article from an aqueous slurry that contains a plurality of fibers.

### BACKGROUND OF THE INVENTION

The current process for creating soft goods, such as clothing, footwear (e.g., shoe uppers), bags, furniture, medical supplies, cleaning tools and consumables, toys, automotive interior parts, cases and housings for consumer electronics, and other soft goods is often wasteful and includes numerous steps. Within each manufacturing step is a separate, inefficient, labor-intensive process that often requires transport of materials between the steps. Scrap materials (e.g., cloth that is cut but not used) are often simply discarded, adding to the waste in the process. Additionally, raw materials are typically provided in flat shapes and must be formed into the final desired shape, different equipment and processes must frequently be employed when small changes in the final design are implemented, and surface feature and/or texture final design must be added in a secondary operation. These and other shortcomings in the prior art are addressed by the present invention, as disclosed herein.

### SUMMARY OF THE INVENTION

According to one aspect of the present invention, an apparatus is provided for molding a fibrous article, the apparatus including a source for providing an aqueous slurry, a first pressing unit, a first molding screen, a second molding screen, a second pressing unit, and a pressing chamber sleeve that maintains proper alignment of the various aspects of the molding apparatus during operation. The aqueous slurry contains an amount of water and a plurality of fibers. The first and second molding screens have a plurality of openings and, optionally, a secondary relief feature. The first and second molding screens at least partially form a void that is intended to receive an amount of the aqueous slurry. The apparatus includes a heat and pressure source that removes at least some to substantially all of the water from the aqueous slurry and bonds the plurality of fibers to one another resulting in the fibrous molded article.

According to another aspect of the present invention, the openings in the first and second molding screens are preferably between 0.1 mm to approximately 50 mm in diameter and, more preferably, between 0.5 mm and approximately 10 mm in diameter, or even more preferably between 0.5 mm and 2 mm.

According to a further aspect of the invention, the secondary relief feature of the first and/or second molding screens imparts one or more features onto a surface of the solid fibrous molded article.

According to an even further aspect of the present invention, the slurry can also contain at least one of a starch, a surfactant, a water retention agent, a viscosifier, a crosslinker, a binding agent, a pH modifier and a charge modifier mixed therein.

One advantage of the present invention is the first and second molding screens can be easily designed to create a desired two- or three-dimensional shape.

Another advantage of the present invention is the first and second molding screens can be easily swapped for different molding screens with different shapes.

A further advantage of the present invention is the first and second molding screens can impart a desirable surface feature and/or texture on the solid fibrous molded part during the molding operation.

These and other advantages will be apparent to one of skill in the art in light of the present disclosure and drawings.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows an exploded perspective view of one embodiment of the molding apparatus of the present invention;

FIG. 2 shows a partial perspective exploded view of another embodiment of the molding apparatus of the present invention;

FIG. 3 shows a top view of one embodiment of the first molding screen;

FIG. 4 shows a top view of one embodiment of the second molding screen; and

FIGS. 5A-G shows a series of cross-sectional diagrammatic images of one embodiment of the molding process of the present invention.

### DETAILED DESCRIPTION OF THE INVENTION

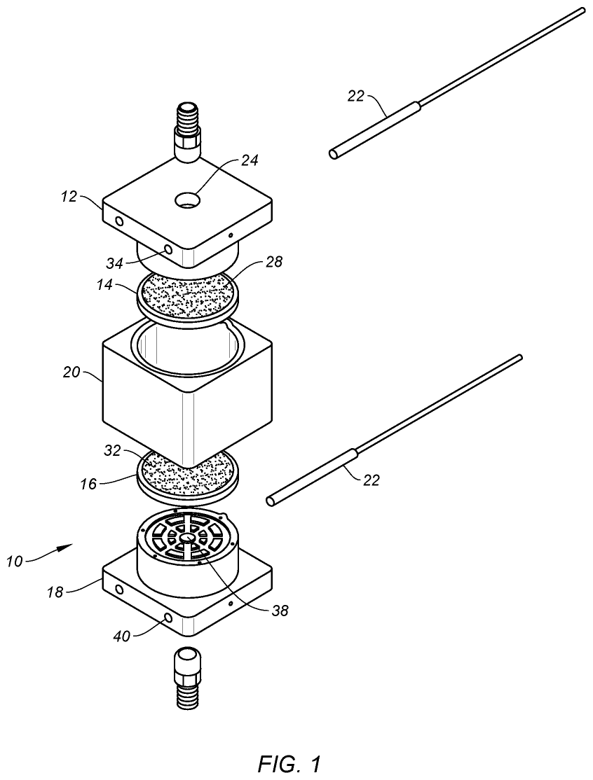

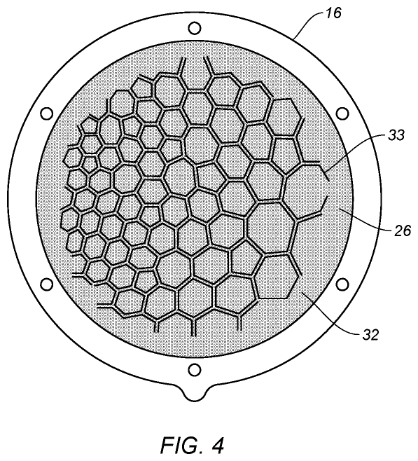

Referring now to FIGS. 1-5, one embodiment of the apparatus 10 of the present invention that is capable of molding an article having at least one contour, as well as at least one surface that has a texture, pattern and/or other surface characteristics desired by the end user. In the embodiment shown, the first pressing unit 12, first molding screen 14, second molding screen 16, lower pressing unit 18, a pressing chamber sleeve 20, and a heating apparatus 22. Common articles (or components thereof) formed using the methods and apparatus 10 disclosed herein include clothing, footwear (e.g., shoe uppers), bags, furniture, medical supplies, cleaning tools and consumables, toys, automotive interior parts, cases and housings for consumer electronics, and other soft goods. Examples of clothing articles include, but are not limited to, shirts, shorts, dresses, skirts, pants, socks, vests, sweaters, scarves, hats, gloves, mittens, and undergarments. Examples of bags include, but are not limited to, handbags, purses, backpacks, bookbags, satchels and clutches. Examples of automotive interior parts include, but are not limited to, interior panels, interior trim, seat upholstery and covers, floor mats, dashboard panels and covers and steering wheel covers. Examples of medical applications include slings, casts, wipes, bandages, artificial limbs, support garments, posture correcting garments, brace supports, canes, crutches and protective coverings. The above listing of articles is intended to be exemplary and non-limiting.

The method and apparatus 10 of the present invention is used in conjunction with an aqueous solution that includes a plurality of fibers (“the slurry 23”). The slurry 23 can include natural fibers, synthetic fibers or a combination thereof. Examples of natural, or biobased, fibers include, but are not limited to, pulp, lyocell, hemp, and wool. Examples of synthetic fibers include, but are not limited to, nylon and polyester. The slurry 23 may additionally include starches, surfactants, water retention agents, viscosifiers, crosslinkers, binding agents, and/or pH and charge modifiers. The above listing of ingredients is intended to be exemplary and non-limiting. The molding process converts the slurry 23 into a solid fibrous molded part 25 having a desired shape and surface features by draining and/or evaporating the water from slurry 23 during the molding process. One suitable slurry is disclosed in U.S. patent application Ser. No. 17/466,792, the disclosure of which is hereby incorporated by reference.

An example of the aforementioned slurry may contain but is not limited to the following content: water (20-99.99%), fibers (0.0075-60%), other additives (0.0025-20%).

The slurry 23 can be created by combining the fibers, water and any other ingredients desired into a mixer (not shown). Once in the mixer, the ingredients are mixed until all ingredients are dispersed, and the slurry 23 takes on the form of a foam-like solution or homogeneous fiber dispersion.

Subsequent fiber modifiers and/or coatings to the final solid fibrous molded part 25 can be added that include natural or biobased waxes, latexes, and/or polyurethanes.

Referring now to FIG. 1, the first pressing unit 12 includes a first inlet 24 that can be used as a port to apply either a vacuum (i.e., negative pressure) or positive pressure, or to provide airflow or heat to the interior of the apparatus 10 before, during or after the molding process. The first inlet 24 may be adapted to receive a removable adapter that may be attachable to a hose or the like that is, e.g., fluid communication with a heat, airflow, vacuum and/or positive pressure source (not shown). The first pressing unit also provides the structural stability to one side of the apparatus 10 enabling significant pressure (e.g, from a hydraulic device) to be applied to the slurry 23 during the molding process. Additional ports may be included in the first pressing unit to provide for, e.g., drainage of the water from the slurry 23 during the molding process. Additionally, the first pressing unit 12 may also include one or more slots 34 for receiving a heating apparatus 22.

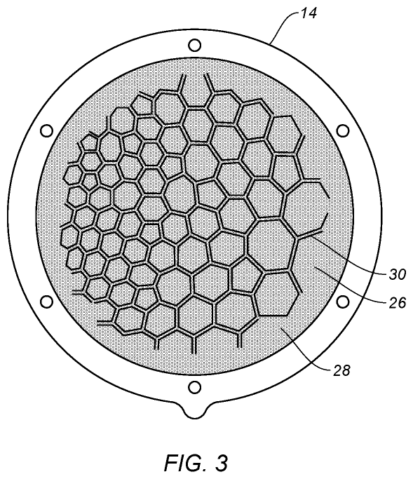

Referring now to FIGS. 1 and 3, the first molding screen 14 is generally a perforated molding screen. The first molding screen 14 partially defines a void 26 in which the slurry 23 is molded into a solid. The first molding screen can be substantially flat or, more preferably defines a three-dimensional shape. The first molding screen may be a positive mold or a negative mold. The first molding screen 14 preferably includes a series of openings 28 that are sized to permit water to drain therethrough and/or steam to pass therethrough during the molding process. The openings 28 are also preferably sized to retain the fibers in the slurry 23 within the void as the slurry 23 is molded into a solid during the molding process. For example, openings 28 have a diameter preferably range from approximately 0.1 mm to approximately 10 mm, and openings 28 between approximately 0.5 mm and approximately 2 mm have been found to have particular utility. The size of the openings 28 may be selected based on a number of factors, including the size of the fibers in the slurry 23, the amount of water necessary for draining, and the surface texture of the final molded product. The first molding screen 14 may also include secondary relief patterns 30. In the embodiment shown the secondary relief patterns are generally shown as being hexagonal in shape. For example, the relief patterns may be raised into the void 26 or depressed away from the void 26, or a combination thereof. In addition, the secondary relief patterns 30 are not limited to hexagonal and may take on any shape or shapes desired by designer. For example, the relief patterns could optionally define text on the finished molded product. The apparatus 10 may function with a variety of first molding screens 14 that can be swapped out depending on the desired final product.

Referring now to FIGS. 1, 2 and 4, the second molding screen 16, like the first molding screen 14, is generally a perforated molding screen. The second molding screen 16 partially defines the void 26 in which the slurry 23 is molded into a solid. In the embodiment shown, the first and second molding screens 14, 16 together define the entire void 26. However, in some embodiments, additional screens (e.g., a third, fourth, etc) screen may be used to also define the void 26. The second molding screen 16 provides a corresponding (but opposite) shape to the first molding screen 14 such that the finished molded part has a substantially uniform cross section. Alternatively, the second molding screen 16 can have a completely different shape altogether from the first molding screen 14, depending on the application of the material output. Similar to the first molding screen 14, this second molding screen 16 can be changed out and customized, to exude different materials characteristics, to include (but not limited to): shape, texture, and pattern. The openings 32 are also preferably sized to retain the fibers in the slurry 23 within the void as the slurry 23 is molded into a solid during the molding process. For example, openings 32 have a diameter preferably range from approximately 0.1 mm to approximately 50 mm, and openings 28 between approximately 0.5 mm and approximately 10 mm have been found to have particular utility. Even more preferably, the openings are between approximately 0.5 mm and approximately 2 mm. The size of the openings 32 may be selected based on a number of factors, including the size of the fibers in the slurry 23, the amount of water necessary for draining, and the surface texture of the final molded product. The openings 32 can be the same or different to the size and shape of the openings 28 in the first molding screen 14. The secondary molding screen 16 may also include secondary relief patterns 33 similar to those described in conjunction with the first molding screen 14.

The first and second molding screens 14, 16 can be made from high-grade stainless steel, other resistant metals including Inconel types, resistant plastics such as polyoxymethylenes (e.g., Delrin®), and fluorocarbon-based polymers (e.g., Teflon™) and durable ceramics such as silicon carbide, alumina, or other materials similarly known to have suitable properties. The material may also be coated to ensure better stability and/or release of the part. The first and second molding screens 14, 16 can be 3D-printed or, for example, machined. The openings in the first and second molding screens 14, 16 allow for fluid flow from the slurry 23 and drainage out of the apparatus 10 by way of negative or positive pressure applied during the molding process. In some embodiments, it may be necessary to include support ribs or other features (not shown) to ensure structural stability of the first and second molding screens 14, 16 during repeated use under high temperatures and pressures.

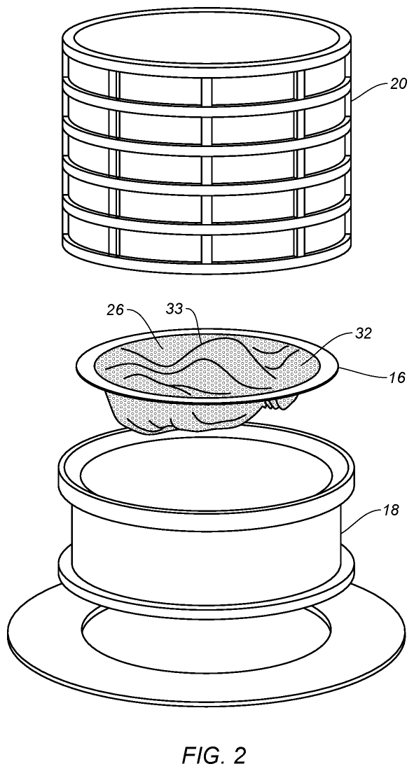

Referring now to FIGS. 1 and 2, the second pressing unit 18 includes a second inlet 38 that can be used as a port to apply either a vacuum or pressure, or to provide airflow or heat to the interior of the apparatus 10 before, during or after the molding process. The second inlet 38 may be adapted to receive a removable adapter that may be attachable to a hose or the like that is, e.g., fluid communication with a heat, airflow, vacuum and/or pressure source (not shown). The first pressing unit also provides the structural stability to one side of the apparatus 10 enabling significant pressure (e.g, from a hydraulic device) to be applied to the slurry 23 during the molding process. For example, hydraulic pressure of up to 1000 psi may be necessary depending on the desired end product. Additional ports may be included in the first pressing unit to provide for, e.g., drainage of the water from the slurry 23 during the molding process. Additionally, the second pressing unit 18 may also include one or more slots 40 for receiving a heating apparatus 22.

The negative and positive pressures applied during the molding process via, e.g., the first inlet 24 and the second inlet 38, can vary based on the needs of the particular needs of the molded product. However, in most applications, negative pressure down to 14.7 psi or positive pressures up to 500 psi may be applied via connected inlet 24, 38 and has been shown to have particular utility.

Referring now to FIGS. 1 and 2, the pressing chamber sleeve 20 at least partially surrounds the first and second pressing units 12, 18 during operation. The pressing chamber sleeve 20 at least partially encloses aspects of the system, ensures proper mold and pressing alignment and ensures the apparatus 10 stays in alignment under significant pressure and repeated use. The pressing chamber sleeve can be made from high-grade stainless steel, other resistant metals including Inconel types, resistant plastics such as polyoxymethylenes (e.g., Delrin®), fluorocarbon-based polymers (Teflon®), or other materials known to have similar suitable properties. The material may also be coated to ensure better stability and/or release of the part.

Referring now to FIG. 1, at least one heating apparatus 22 (e.g., a heating cartridge) can be utilized during typical operation of the apparatus 10. In some embodiments, the heating required can be defined as wattage required to hit temperature setpoint within a given time. Typical wattage ranges from 1500 W-2500 W; however, the range may vary depending on the size of molds used, dwell time, cycle time, water content and ambient temperature. The pressure and heat can be utilized to effectively remove the desired amount of the remaining fluid (e.g., water) from the slurry 23 and bond the fibers to one another such that a final solid fibrous molded part 25 is formed. In some embodiments, it may be desirable to remove substantially all of the water from the slurry 23. In other embodiments, it be desirable to tune the system maintain most, if not all, of the water in the slurry 23.

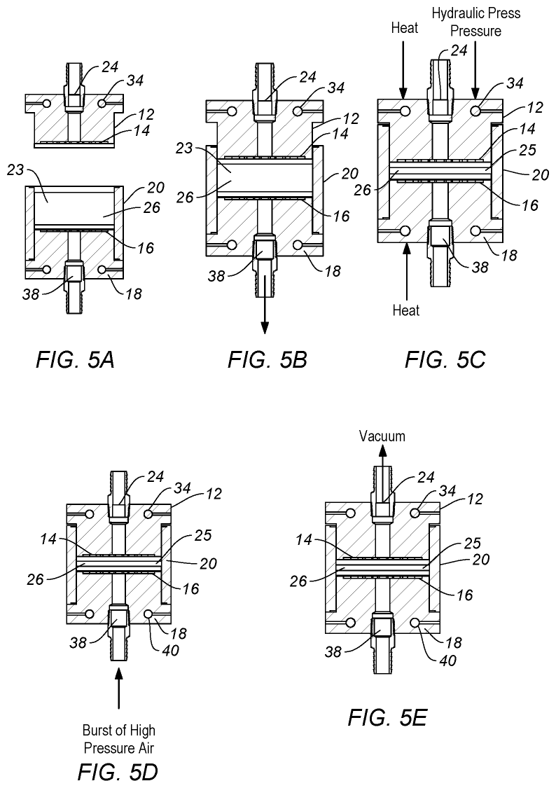

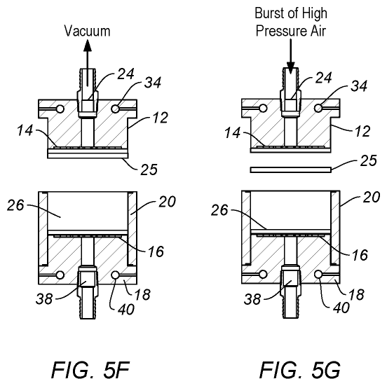

Referring to FIGS. 5A-G, during typical operation, a first molding screen 14 is positioned on the first pressing unit 12 and a second molding screen 16 is positioned on the second pressing unit 18. The first and second pressing units 12, 18 are positioned such that they are slidably engaged within the pressing chamber sleeve.

The slurry 23 is provided into the void 26 partially formed by the second molding screen 16. The first pressing unit 12, along with the first molding screen 14, is then slid partially towards the second molding screen 16 and the second pressing unit 18, as shown in FIG. 5B. A vacuum is applied to the second inlet 38 such that water from the slurry 23 is drained and the slurry 23 commences dewatering. Referring now to FIG. 5C, heat is applied to the first and/or second pressing units 14, 18 via one or more heating apparatus 22 and pressure is also applied to the first and/or second pressing units 12, 18 via, e.g., a hydraulic press such that the first pressing unit 12 continues to slide relative to the pressing chamber sleeve 20 towards the second pressing unit 18 until it reaches the pre-determined final position. The heat and pressure are applied for a pre-determined amount of time to drain and/or evaporate the water from the slurry 23 and to bond the fibers to one another resulting in a solid fibrous molded part 25. The secondary relief patterns 30 and openings 28, 32 in the first and second molding screens 14, 16 impart a texture on the surface of the solid fibrous molded part 25.

Referring now to FIGS. 5D and 5E, short bursts of high-pressure air are applied through the second inlet 38 and a negative pressure may be applied through the first inlet 24. Referring now to FIG. 5F, the first pressing unit 12, along with the first molding screen 14 and the final solid fibrous molded part 25 are slid relative to the pressing chamber sleeve 20 away from the second molding screen 16. Referring now to FIG. 5G, a burst of high-pressure air is applied through the first inlet 24 to release the solid fibrous molded part 25.

In some embodiments, the solid fibrous molded part 25 may need additional time outside the mold to dry. Additionally, some post mold forming steps may be carried out to achieve the desired shape. Optionally, additional coatings, or other secondary operations can be carried out on the final solid fibrous molded part 25 after removal from the apparatus.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A method for forming an article, comprising:
providing an apparatus containing a first molding screen and a second molding screen, the first and second molding screens combining to at least partially define a void, the first molding screen includes a plurality of openings and the second molding screen includes a plurality of openings;
forming an aqueous slurry that contains an amount of water and includes a plurality of fibers;
adding the aqueous slurry to a void between the first and second molding screens;
draining at least some of the water from the aqueous slurry through at least one opening in at least one of the first and second molding screens;
applying heat and pressure to the aqueous slurry to substantially remove all of the water from the slurry and to bond at least some of the plurality of fibers together to form a final solid fibrous molded part.

2. The method of claim 1, wherein the plurality of fibers includes at least one type of natural fiber.

3. The method of claim 1, wherein the plurality of fibers includes at least one type of synthetic fiber.

4. The method of claim 1, wherein the plurality of fibers includes at least one type of natural fiber and one type of synthetic fiber.

5. The method of claim 1, wherein the aqueous slurry includes at least one of the following: a starch, a surfactant, a water retention agent, a viscosifier, a crosslinker, a binding agent, a pH modifier and a charge modifier.

6. The method of claim 1, wherein the first molding screen includes a secondary relief pattern that imparts a surface feature on the final fibrous molded part.

7. The method of claim 1, wherein the second molding screen includes a secondary relief pattern that imparts a surface feature on the final fibrous molded part.

8. An apparatus for molding a fibrous molded article, comprising:
a source for providing an aqueous slurry that contains an amount of water and a plurality of fibers;
a first molding screen that is positioned on a first pressing unit, the first molding screen having a plurality of openings;
a second molding screen that is positioned on a second pressing unit, the second molding screen having a plurality of openings;
a pressing chamber sleeve slidably engaged with the first pressing unit and the second pressing unit;
wherein the first and second molding screens at least partially form a void that is intended to receive an amount of the aqueous slurry;
wherein the apparatus includes a heat and pressure source that removes at least some of the water from the aqueous slurry and bonds the plurality of fibers to one another resulting in the fibrous molded article.

9. The apparatus of claim 8, wherein the size of the openings in the first molding screen are between approximately 0.1 mm to approximately 50 mm in diameter.

10. The apparatus of claim 9, wherein the size of the openings in the first molding screen are between 0.5 mm and approximately 10 mm in diameter.

11. The apparatus of claim 10, wherein the size of the openings in the first molding screen are between 0.5 mm and approximately 2 mm in diameter.

12. The apparatus of claim 8, wherein the size of the openings in the second molding screen are between approximately 0.5 mm to approximately 50 mm in diameter.

13. The apparatus of claim 12, wherein the size of the openings in the second molding screen are between 0.5 mm and approximately 10 mm in diameter.

14. The apparatus of claim 13, wherein the size of the openings in the second molding screen are between 0.5 mm and approximately 10 mm in diameter.

15. The apparatus of claim 8 wherein the first molding screen includes at least one secondary relief feature that imparts one or more features onto a surface of the solid fibrous molded article.

16. The apparatus of claim 8 wherein the second molding screen includes at least one secondary relief feature that imparts one or more features onto a surface of the fibrous molded article.

17. The apparatus of claim 8, wherein the source for providing an aqueous slurry that contains an amount of water and a plurality of fibers also includes at least one of a starch, a surfactant, a water retention agent, a viscosifier, a crosslinker, a binding agent, a pH modifier and a charge modifier mixed therein.
